(19) United States
(12) Patent Application Publication
(10) Pub. No.: US 2018/0269647 A1
(43) Pub. Date: Sep. 20, 2018

(54) PORRO PRISM STABILIZED LASER SYSTEM

(71) Applicant: BAE SYSTEMS INFORMATION AND ELECTRONIC SYSTEMS INTEGRATION INC., Nashua, NH (US)

(72) Inventors: Michael J. CHOINIERE, Merrimack, NH (US); Egor V. DEGTIAREV, Merrimack, NH (US)

(21) Appl. No.: 15/297,339

(22) Filed: Oct. 19, 2016

Related U.S. Application Data
(60) Provisional application No. 62/257,382, filed on Nov. 19, 2015.

(51) Int. Cl. H01S 3/136; H01S 3/123; H01S 3/081

(52) U.S. Cl. CPC H01S 3/136; H01S 3/091; H01S 3/0811; H01S 3/123

(57) ABSTRACT

A porro prism stabilized q-switched laser system including a gain material, a partial reflector optically connected to the gain material, an oscillating mirror operably connected to the gain material, and a porro prism optically connected to the oscillating mirror. The system has a first path located between the partial reflector and the oscillating mirror, and a second path located between the oscillating mirror and the porro prism. The stabilized laser system having larger alignment tolerances making for more stable and less expensive systems. The stabilized laser system having a shorter cavity length than traditional q-switched laser systems.

### CROSS REFERENCE TO RELATED APPLICATIONS

This Application claims the benefit of U.S. Provisional Application No. 62/257,382, filed Nov. 19, 2015, the contents of which are incorporated by reference herein in their entirety.

### FIELD OF THE DISCLOSURE

The present disclosure relates to lasers and more particularly to the use of prisms to stabilize lasers.

### BACKGROUND OF THE DISCLOSURE

Current q-switch laser components are designed in a linear fashion. The current laser components include a partial reflector, a gain material, and an oscillating mirror. The linear fashion design requires tight tolerances between the partial reflector and the oscillating mirror. The difficulty of achieving this tight tolerance traditionally drives the cost of the device up. The tight tolerance also traditionally lowers the overall reliability of the device. Current systems also require that the cavity length remain long, which reduces the stability of the cavity.

In contrast, one embodiment of the laser system of the present disclosure allows for lower cost and more reliable laser systems by replacing the traditional q-switch with a porro prism. In one embodiment of the laser system of the present disclosure, a porro prism is added to a traditional q-switch system. In certain embodiments, the addition of the porro prism creates a folded resonator configuration which reduces the cavity length of the laser system and increases the overall stability of the laser system.

### SUMMARY OF THE DISCLOSURE

It has been recognized that current laser systems are costly and have very narrow alignment tolerances. In certain embodiments of the laser system of the present disclosure, introduction of a porro prism to a laser system increases the alignment tolerance of the laser system thereby producing a low cost and more reliable system.

One aspect of the present disclosure is a stabilized q-switch laser system comprising: an input beam for providing radiation to a gain medium; an output beam resulting from lasing of the gain medium; an optical cavity having a length, comprising, a partial reflector having a first axis and a second axis; an oscillating mirror having a first axis and a second axis; a porro prism having a first axis and a second axis; and the gain medium; a first path defining the orientation of the partial reflector through the gain medium with respect to the oscillating mirror, wherein a portion of the radiation coming from the gain material is reflected back to the gain medium, and some portion of the radiation is emitted through the partial reflector as the output beam, the oscillating mirror having alignment tolerances and is configured to rotate about an axis to modulate the output beam; a second path defining the orientation of the oscillating mirror with respect to the porro prism, wherein when the porro prism (308) is aligned with the oscillating mirror (306), radiation is directed back into the gain medium (302) to modulate the lasing of the gain medium and the presence of the porro prism relaxes the alignment tolerances of the oscillating mirror to about 2000 microradians (μrad) to form a stabilized q-switch laser system.

One embodiment of the stabilized laser system is wherein the length of the cavity is shorter than a traditional laser system by utilizing a folded resonator configuration.

Another aspect of the present disclosure is a stabilized laser system comprising: an input beam for providing radiation to a gain medium; an output beam resulting from lasing of the gain medium; an optical cavity having a length, comprising, a partial reflector having a first axis and a second axis; a porro prism having a first axis and a second axis; and the gain medium; a path defining the orientation of the partial reflector through the gain medium with respect to the porro prism, wherein a portion of the radiation coming from the gain medium is reflected back to the gain medium, and some portion of the radiation is emitted through the partial reflector as the output beam; the porro prism is configured to rotate about an axis and radiation is directed back into the gain medium to modulate the lasing process, the porro prism nullifies the misalignment error between the partial reflector and the axis of rotation for the porro prism to provide alignment tolerances of about 2000 microradians (μrad) to form a stabilized laser system.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a diagrammatic view of a traditional laser system.

FIG. 2 shows a diagrammatic view of a laser system in accordance with one embodiment of the present disclosure.

FIG. 3 shows a diagrammatic view of a laser system in accordance with one embodiment of the present disclosure.

### DETAILED DESCRIPTION OF THE DISCLOSURE

Current q-switch laser systems are designed in a linear fashion. Typical components include a partial reflector, a gain material, and an oscillating mirror spinning on a motor. The linear fashion design requires long cavities and tight tolerances between the partial reflector and the oscillating mirror. The difficulty of achieving this tight tolerance traditionally drives the cost of the device up. The tight tolerance also traditionally lowers the overall reliability of the device. In current systems, the oscillating mirror acts as a Q-switch.

It is understood that Q-switching is achieved when some type of variable attenuator is placed inside a laser's optical resonator. When the attenuator is functioning, light which leaves the gain medium does not return, and lasing cannot begin. This attenuation inside the cavity corresponds to a decrease in the quality factor or “Q-factor” of the optical resonator. This variable attenuator is commonly called a “Q-switch.”.

Typically, a laser medium is pumped while the Q-switch is set to prevent feedback of light back into the gain medium (e.g., an optical resonator with low Q). This produces a population inversion and may be used to charge the crystal. At that time, laser operation does not occur since there is no feedback from the resonator. Because the rate of stimulated emission is dependent on the amount of light entering the medium, the amount of energy stored in the gain medium increases as the medium is pumped. Due to losses from spontaneous emission and other processes, after a certain period of time the stored energy reaches a maximum level (i.e., becomes gain saturated). At that time, the Q-switch device switches from low Q to high Q, allowing feedback into the gain medium and the process of optical amplification by stimulated emission begins. Because of the large amount of energy already stored in the gain medium, the intensity of the light in the laser resonator builds up very quickly. The energy stored in the medium also depletes quickly. This results in a short pulse of light with high peak intensity.

It is understood that there are two main types of Q-switching: active and passive. In some systems, the Q-switch is active and is an externally controlled variable attenuator. This may be a mechanical device such as a shutter, a chopper wheel, or a spinning mirror placed inside the cavity, or it may be some form of acousto-optic device, a magneto-optic effect device or an electro-optic device.

In one embodiment of the laser system of the present disclosure a lower cost and more reliable laser system is created by replacing a traditional q-switch with a porro prism. In certain embodiments, a porro prism is added to a traditional q-switch system to increase the alignment tolerances needed for efficient lasing.

A porro prism is a reflection prism. Generally, a porro prism consists of a block of glass with two right-angle triangular end faces. In operation, light enters a large rectangular face of the prism, undergoes total internal reflection by reflecting off the two sloped faces, and exits again through the large rectangular face. Because the light exits and enters the prism only at normal incidence, the prism is not dispersive. Furthermore, a beam travelling through a porro prism is rotated by 180° and exits in the opposite direction offset from its entrance point. Since the beam is reflected twice, the handedness of the beam remains unchanged. Similarly, roof prisms are reflective optical prisms containing two faces that meet at a 90° angle. These two 90° faces resemble the roof of a building. Reflection from the two 90° faces returns a beam that is flipped across the axis where the faces meet.

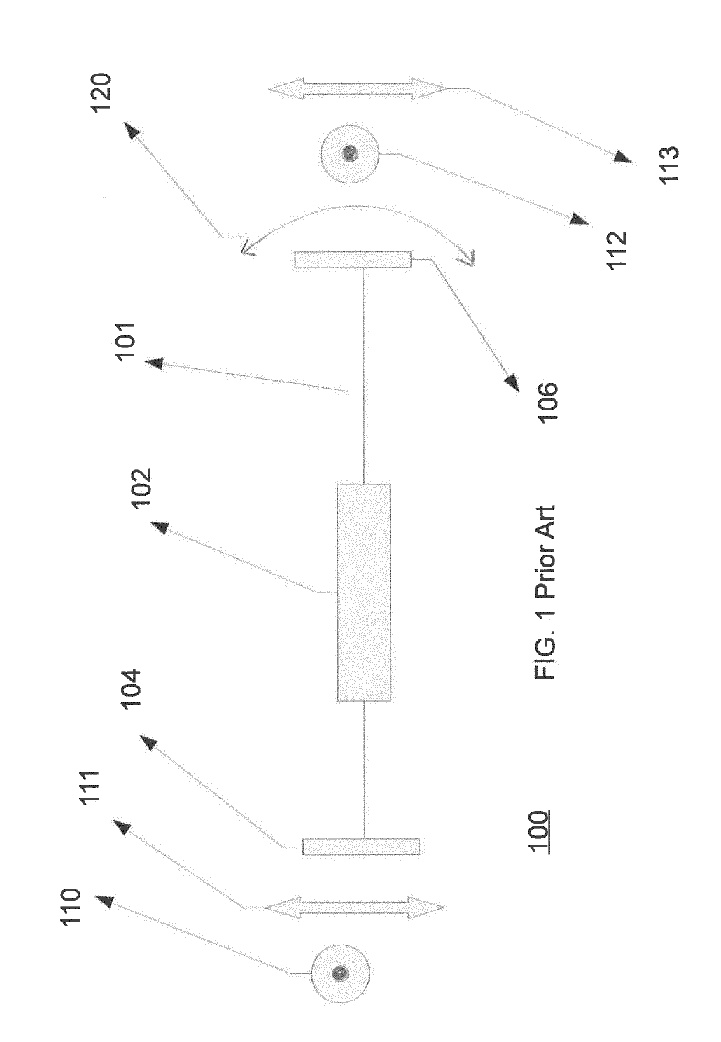

Referring to FIG. 1, a diagrammatic view of a traditional laser system is shown. More particularly, a traditional laser system (100) has a gain material (102) configured to produce a laser beam. The gain medium (102) is pumped by an energy or radiation source via and input beam (not shown). The traditional system has a partial reflector (104) with two axes of orientation. Still referring to FIG. 1, the first axis of the partial reflector (111) is in the plane of the page and the second axis of the partial reflector (110) extends into and out of the page. The partial reflector (104) is optically connected to the gain material (102) such that a portion of radiation coming from the direction of the gain material (102) is reflected back, and some is emitted through the partial reflector (104) as an output beam (not shown).

Still referring to FIG. 1, an oscillating mirror (106) is optically connected to the gain material (102), such that when the oscillating mirror (106) is aligned with the partial reflector (104), radiation is directed back into the gain medium (102) to begin the lasing process. Thus, the radiation beam (101) extends at least through the partial reflector (104), through the gain medium (102) and to the oscillating mirror (106). The oscillating mirror (106) has two axes of orientation. The first axis of the oscillating mirror (112) extends into and out of the page and the second axis of the oscillating mirror (113) is in the plane of the page. Additionally, an arc (120) represents the manipulation of the oscillating mirror (106) as used to attenuate the laser system.

Current systems need near perfect alignment of the partial reflector (104) and the oscillating mirror (106) so that the energy does not skew and/or bounce out of the cavity. Typical systems require tolerance to within 200 microradians (μrad), or about 0.01 degrees, regardless of temperature and other environmental conditions. Thermal gradients and coefficient of thermal expansion (CTE) differences between materials (glass, metals, etc.) generate asymmetry in the structure; resulting in twisting and bending of the optical bench or housing. The twisting and bending detune the aliment between the mirrors beyond the 200 μrads needed for effectively lasing. Typically, the oscillating mirror (106) is mounted to a motor (not shown) and the motor is used to move, or spin, the mirror. It has been recognized that the motor must be precise and even factors like loose bearing can adversely affect the functionality of the laser system in the field. The mirror oscillation will auto-align with the rotational axis as it swings through the optimum alignment, but the other axis needs to be held consistently within the 200 μrads for effective lasing. (Given the motor bearings, the precision needed for spinning to control the pump time and lase time, and other factors, this limits aligning the motor shaft within 200 μrads to the partial reflector (104) in practice; thus this approach is seldom employed.

Q-switched lasers are often used in applications which demand high laser intensities in nanosecond pulses, such as metal cutting or pulsed holography. However, Q-switched lasers can also be used for measurement purposes, such as for distance measurements (range finding) by measuring the time it takes for the pulse to get to some target and the reflected light to get back to the sender. Pulse lasers also can be used for target designation, missile jamming, optical jamming, LIDAR, and the like.

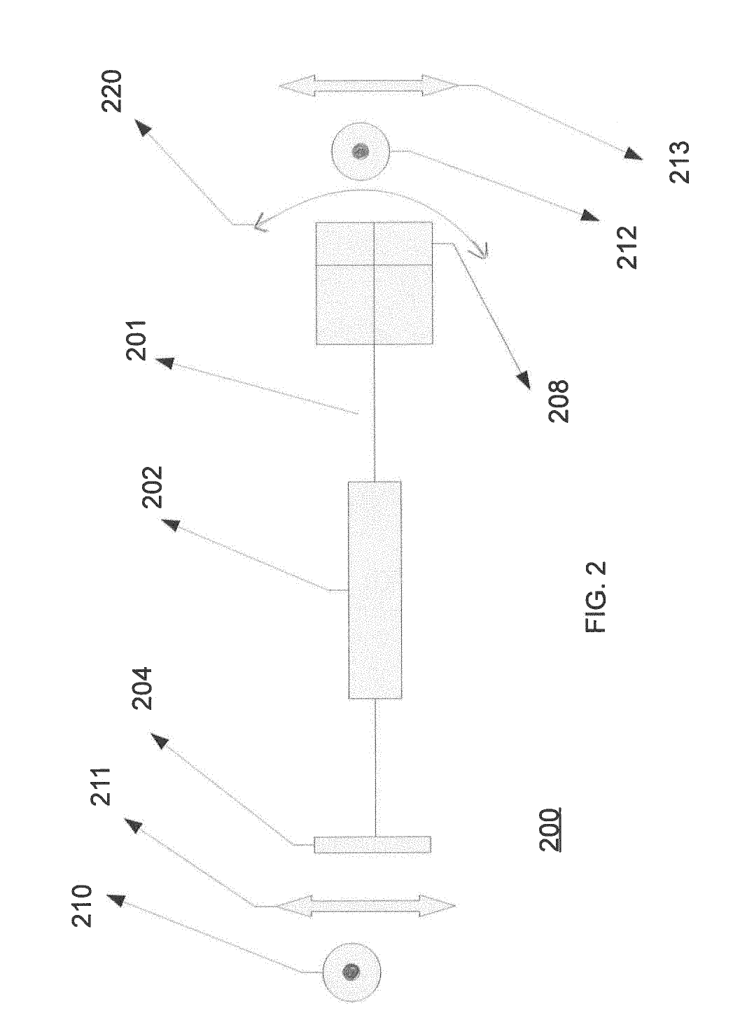

Referring to FIG. 2, a diagrammatic view of a laser system in accordance with one embodiment of the present disclosure is shown. More particularly, a laser system (200) having a gain material (202) is configured to produce a laser beam. Some gain medium may include Nd:YAG (neodymium-doped yttrium aluminum garnet; Nd:Y3Al5O12), Er:glass, and the like, generating laser pulses ranging from about 0.5 to about 150 mJ, and having pulses ranging from about 0.05 to about 15 nanoseconds depending on the cavity configuration. The gain medium (202) is pumped by an energy or radiation source via and input beam (not shown). In certain embodiments, a partial reflector (204) is optically connected to the gain material (202), such that a portion of the radiation coming from the direction of the gain material is reflected back to the gain medium (202), and some portion of the radiation is emitted through the partial reflector (204) as an output beam (not shown) during the lasing process. The partial reflector typically reflects from about 70% to about 90% of the energy allowing about 10% to about 30% of the energy to leave the cavity in the form of the laser energy/beam.

Still referring to FIG. 2, the partial reflector (204) has two axes of orientation. A first axis of the partial reflector (211) is in the plane of the page and a second axis of the partial reflector (210) extends into and out of the page. In certain embodiments, a porro prism (208) is optically connected to the gain material (202) such that when the porro prism (208) is aligned with the partial reflector (204), radiation is directed back into the gain medium (202) to begin the lasing process. The porro prism (208) has two axes of orientation: a first axis of the porro prism (212) extends into and out of the page and a second axis of the porro prism (213) is in the plane of the page. Additionally, an arc (220) represents the manipulation of the porro prism (208) as used to attenuate the laser system.

In certain embodiments of the system of the present disclosure, the laser is a solid state laser. In other embodiments of the system, the laser is a dye laser. In still other embodiments, the laser is a gas laser.

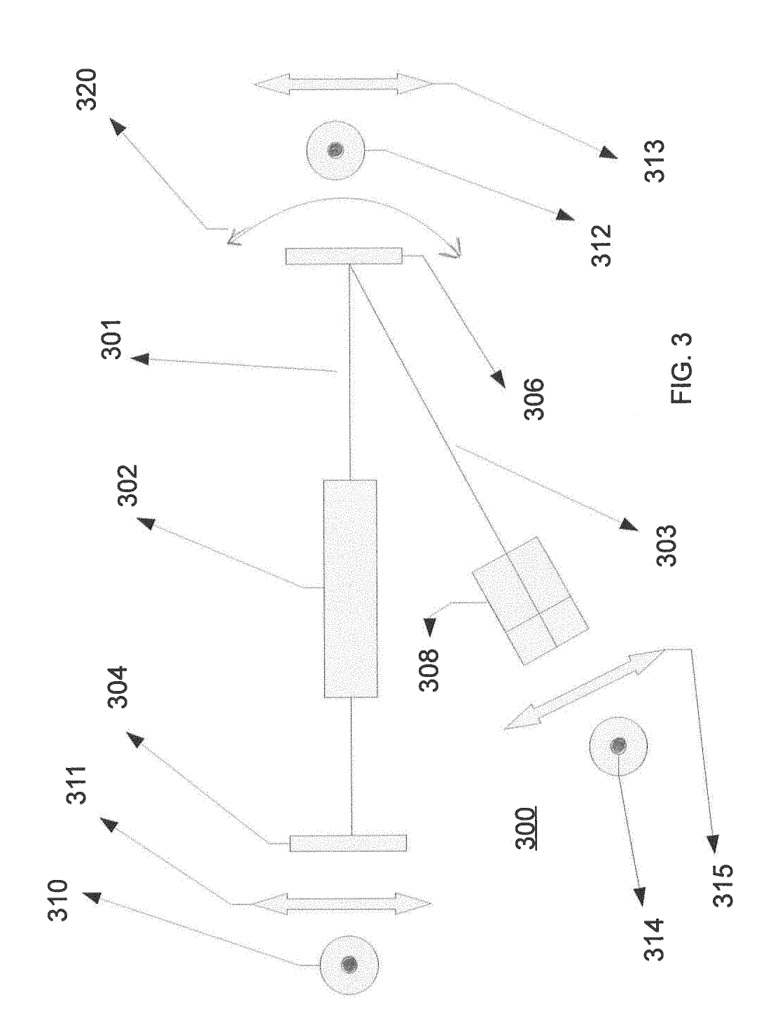

Referring to FIG. 3, a diagrammatic view of a laser system in accordance with one embodiment of the present disclosure is shown. More particularly, a laser system (300) having a gain material (302) is configured to produce a laser beam. The gain medium (302) is pumped by an energy or radiation source via and input beam (not shown). In certain embodiments, a partial reflector (304) is optically connected to the gain material (302), such that a portion of the radiation coming from the direction of the gain material is reflected back to the gain medium (302), and some portion of the radiation is emitted through the partial reflector (304) as an output beam (not shown) during the lasing process. The oscillating mirror (306) is operably connected to the gain material (302), such that when the oscillating mirror (306) is aligned with the partial reflector (304), radiation is directed back into the gain medium (302) to begin the lasing process.

Still referring to FIG. 3, in certain embodiments the beam (301) extends from the partial reflector (304) through the gain medium (302) to the oscillating mirror (306). The partial reflector (304) has two axes of orientation. A first axis of the partial reflector (311) is in the plane of the page and a second axis of the partial reflector (310) extends into and out of the page. The oscillating mirror (306) has two axes of orientation: a first axis of the oscillating mirror (312) extends into and out of the page and a second axis of the oscillating mirror (313) is in the plane of the page. Additionally, an arc (320) represents the manipulation of the oscillating mirror (306) as used to attenuate the laser system. The mirror is relatively light weight as compared to the porro prism allowing a smaller motor or higher speed oscillation. Oscillation is preferred since the pump time and the Laser PRF time may not be compatible with a simple spinning mirror. By using a porro prism to compensate for the lack of perfection in the required timing and orientation of the mirror, it is possible to simply “flick” the mirror to control pump time and lase time rather than having a spinning mirror with all of the problems associated with that system.

In certain embodiments, a porro prism (308) is optically connected to the gain material (302), such that when the porro prism (308) is aligned with the oscillating mirror (306), radiation is directed back into the gain medium (302) to begin the lasing process. The porro prism (308) has two axes of orientation: a first axis of the porro prism (314) extends into and out of the page and a second axis of the porro prism (315) is in the plane of the page. The one or more of the axes of the partial reflector (310, 311) are aligned with one or more of the axes of the oscillating mirror (312, 313). In some embodiments, a porro prism (308) is optically connected to the oscillating mirror (306). In certain embodiments, the porro prism (308) is aligned to the oscillating axis of the oscillating mirror (306). The alignment of the first axis (312) of the oscillating mirror (306) to the first axis (310) of the partial reflector (304) is nullified by the use of the porro prism (308). A second path (303) carries the system beam between the oscillating mirror (306) and the porro prism (308).

In one embodiment of the laser system of the present disclosure, the laser system includes a gain material configured to produce a laser beam, a partial reflector operably connected to the gain material, an oscillating mirror operably connected to the gain material, and a first path comprising the system beam located between the partial reflector and the oscillating mirror. The wavelength is dependent on the laser gain material (e.g., Nd:YAG (neodymium-doped yttrium aluminum garnet); Nd:Y3Al5O12 is about 1.06 μm and Er:glass is about 1.53 μm). There are many other lasers that can be used depending on the desired application. The components of a system can range in size from chip components measured in a few mm to high power components measured in a few cm. In one embodiment of the laser system of the present disclosure, a porro prism is operably connected to an oscillating mirror and aligned with an oscillation axis of the oscillating mirror. In certain embodiments, the porro prism increases the alignment tolerance of the laser system by ten times or greater; increasing the 200 μrads alignment to a few mrads.

In some embodiments, the increase in the alignment tolerance allows the replacement of an optical q-switch oscillating mirror with a mechanical q-switch oscillating mirror. This replacement is beneficial because mechanical q-switch oscillating mirrors are traditionally less expensive than optical q-switch oscillating mirrors. This change to an electrical optical switch (EO) can lower costs by about 10 times. These less expensive switches are typically unable to rotate reproducibly over time and at operating temperatures within the 200 μrad needed in standard laser systems. The addition of a porro prism alleviates that system requirement making them a viable option.

Additionally, current systems require that the cavity length of traditional system remain long, which reduces the stability of the cavity. In certain embodiments of the system of the present disclosure, the use of a porro prism creates a second path comprising the system beam located between the oscillating mirror and the porro prism to form a “folded” resonator configuration.

In one embodiment of the laser system of the present disclosure, the porro prism compensates for axis float of a first axis. In certain embodiments, axis float in a second axis is compensated for by the oscillation motion of the oscillating mirror. In certain embodiments, the compensation of the second axis may only affect laser range finder timing slightly. The LRF timing is not critical since one can measure the actual laser energy as it leaves the range finder and determine time zero for the range calculation.

In one embodiment of the laser system of the present disclosure, the addition of a porro prism may nullify the need for precise alignment of a first axis of the oscillating mirror to a first axis of the partial reflector. In certain embodiments, the folded resonator configuration of the present system may reduce the cavity length of the laser system, which may increase the overall stability of the laser system. The use of a porro prism may increase the alignment tolerance between the oscillating mirror and partial reflector, which may also lower assembly costs. This increased alignment tolerance may enhance overall laser stability as well.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A stabilized q-switch laser system comprising:
an input beam for providing radiation to a gain medium;
an output beam resulting from lasing of the gain medium;
an optical cavity having a length, comprising,
a partial reflector having a first axis and a second axis;
an oscillating mirror having a first axis and a second axis;
a porro prism having a first axis and a second axis; and
the gain medium;
a first path defining the orientation of the partial reflector through the gain medium with respect to the oscillating mirror, wherein a portion of the radiation coming from the gain material is reflected back to the gain medium, and some portion of the radiation is emitted through the partial reflector as the output beam, the oscillating mirror having alignment tolerances and is configured to rotate about an axis to modulate the output beam;
a second path defining the orientation of the oscillating mirror with respect to the porro prism, wherein when the porro prism (308) is aligned with the oscillating mirror (306), radiation is directed back into the gain medium (302) to modulate the lasing of the gain medium and the presence of the porro prism relaxes the alignment tolerances of the oscillating mirror to about 2000 microradians (μrad) to form a stabilized q-switch laser system.

2. The stabilized laser system of claim 1, wherein the length of the cavity is shorter than a traditional laser system by utilizing a folded resonator configuration.

3. A stabilized laser system comprising:
an input beam for providing radiation to a gain medium;
an output beam resulting from lasing of the gain medium;
an optical cavity having a length, comprising,
a partial reflector having a first axis and a second axis;
a porro prism having a first axis and a second axis; and
the gain medium;
a path defining the orientation of the partial reflector through the gain medium with respect to the porro prism, wherein a portion of the radiation coming from the gain medium is reflected back to the gain medium, and some portion of the radiation is emitted through the partial reflector as the output beam;
the porro prism is configured to rotate about an axis and radiation is directed back into the gain medium to modulate the lasing process, the porro prism nullifies the misalignment error between the partial reflector and the axis of rotation for the porro prism to provide alignment tolerances of about 2000 microradians (μrad) to form a stabilized laser system.
